(19) United States
(12) Patent Application Publication
(10) Pub. No.: US 2005/0095572 A1
(43) Pub. Date: May 5, 2005

(54) Methods and systems for providing simulation-based technical training

(75) Inventors: Edward Robert Comer, Austin, TX (US); Baba Z. Buehler, Austin, TX (US); Michael Edward Dahmus, Austin, TX (US); Randy Pond, San Marcos, TX (US); Jason Brian Sugg, Austin, TX (US)

Correspondence Address: Lipsitz & McAllister, LLC, 755 MAIN STREET, MONROE, CT, 06468, US

(73) Assignee: RealVue Simulation Technologies, Inc., Austin, TX (US)

(21) Appl. No.: 10/701,649

(22) Filed: Nov. 4, 2003

(51) Int. Cl. G09B 7/00; G09B 19/00

(52) U.S. Cl. 434/362; 434/219

(57) ABSTRACT

The present invention provides methods and systems for simulation-based technical training on equipment, machinery, and software-based systems. The present invention is enabled by a data-driven simulation kernel. The data-driven simulation kernel encapsulates the structure of the system to be simulated in a data model that is decomposed into its constituent simulation components. The simulation components are structured hierarchically, mirroring the hierarchy of parts within parts in the actual system being simulated. Associated with each simulation component is a set of properties that define the user interface characteristics and states of that simulation component. The behavior of the simulation is driven by the sequence of state changes, specifically reflected as changes to the values of the properties of the constituent simulation components contained in the data model.

### BACKGROUND OF THE INVENTION

The present invention relates to computer-based training systems and methods for training technical skills on equipment, machinery, and software-based systems. More specifically, the present invention relates to simulation-based technical training systems and methods that provide a realistic and immersive environment for technical training on equipment, machinery and software-based systems. The present invention enables simulation-based training that is sufficiently robust and realistic that it may partially or completely displaces the actual equipment for training.

Technical training on equipment, machinery, and software-based systems largely depends on hands-on training using the actual equipment, machinery or system. As such, the training of technical skills is typically accomplished by instructor-led training (ILT) with an adjunct laboratory for practice, or on-the-job training (OJT) using the actual equipment, machinery or system in the field.

Computer-based training systems and methods have focused on electronic delivery of material typically presented by an instructor, including presentations and paper tests. These methods are capable of presenting and testing knowledge about equipment, machinery and systems, but are insufficient for developing and certifying technical skills.

Simulation-based training provides an effective vehicle for learning-by-doing. Most computer-based training systems and methods, including animation-based approaches, have limited user interactivity and insufficient realism to be as effective as simulation.

In order to partially or completely displace use of the actual equipment for training, simulation-based technical training must have the following characteristics:
Provide a realistic, yet abstracted, representation of the equipment, machinery or system, and its behaviors;
Simulate the relevant environment around the equipment, machinery, or system;
Support the user's direct interaction with the simulated system and its simulated environment in a manner directly analogous to interacting with an actual system and its actual environment;
Portray system behaviors in reaction to user interactions that directly mimic the actual system behaviors;
Simulate the relevant interactions of the equipment, machinery, or system with its environment;
Support users' non-linear interactions, where the user may branch, take excursions, make mistakes, or find different ways to accomplish the same result;
Be immersive, by providing a sufficiently realistic-user experience so that the user's interactions match those on the actual equipment, machinery or system;
Support complex sets of user interactions, involving hundreds, thousands, or even tens of thousands of steps or more, representing real-world scenarios; and
Support multiple user procedures, faults, or scenarios reflecting the set of situations that the user may encounter in the field and providing a rich library of scenarios on which to practice and build skills.

True simulation-based training has previously involved expensive software development. As a result, its use has been limited to cases where the equipment is very expensive and where safety or economic consequences are high, such as airline piloting or operating a nuclear power plant.

To be cost-effective for a much broader range of equipment, machinery, or system, more productive systems and methods are required that avoids expensive software development yet enables the development of realistic, immersive and complex simulations.

The simulation-based training methods and systems of the present invention provide the foregoing and other advantages.

### SUMMARY OF THE INVENTION

The present invention relates to computer-based training systems and methods for training technical skills on equipment, machinery, and software-based systems. This includes a wide variety of electrical, mechanical, electro-mechanical, computer-based and physical systems where technical skill training is required. Example vertical application areas include computer and office equipment, communications equipment, diversified engineering and manufacturing, medical instrumentation, and energy services, amongst others. The invention enables technical skills training for pre-sales technical support, customer demos, channel awareness, installation, operation, diagnosis, repair, maintenance, help desk, customer support, and the like.

More specifically, the present invention relates to simulation-based technical training systems and methods that provide a realistic and immersive environment for technical training on equipment, machinery and software-based systems. The invention relates to simulation-based training that is sufficiently robust and realistic that it may partially or completely displaces the actual equipment for training.

Within this scope, the invention provides a simulation-based vehicle for technical skills instruction, practice, and certification. Simulation-based technical training may be executed by students on a personal computer in standalone mode, over a local area network (LAN), or over the Internet or other wide area network (WAN). Students may utilize the simulation-based technical training in a self-paced mode, with an instructor, or in the field, providing just-in-time training.

In an example embodiment of the invention, a system for providing simulation-based technical training is provided. The system includes a data model module for a simulation. The data model module includes a set of simulation components, each of which represents a corresponding component of a system to be simulated. The set of simulation components is structured in a hierarchy which mirrors a hierarchy of the corresponding components of the system. The data model module also includes a set of properties associated with each of the simulation components. The properties define characteristics of a user interface for simulating the respective simulation component and states of the respective simulation component. A user interface is provided for enabling user interactions with the system and providing a visual representation of at least one of the simulation components based on at least one of the properties. At least one behavior driver is provided for specifying respective behaviors of the simulation components corresponding to respective changes of at least one of the properties. An interface engine is also provided for managing the user interface and changing the visual representation based on the property changes in accordance with the at least one behavior driver in response to the user interactions.

The system may also comprise a simulation client for providing application resource management for the simulation during initial simulation launch, execution, and shutdown. The simulation client may also provide initial data definitions for the properties and for a structure of the simulation. The simulation client may initialize the data model module. The simulation client may also configure and control the user interface.

The system may further comprise one or more component libraries, each of which contains a set of reusable simulation components. A one or more third-party user interface libraries may be coupled to the component libraries. The user interface libraries may comprise low-level components that map to visual components in the component libraries for use by a simulation component.

Each simulation component may encapsulate a visual representation of the component, the properties of the component, and predefined behavior of the component. At least one of the simulation components may encapsulate a related simulation component. The simulation components are integrated into a simulation by being referenced in the data model module. At least one of the simulation components may comprise a reusable simulation component.

The visual behavior of the simulation may be managed by the interface engine. Internal behavior of the simulation may be managed by the at least one behavior driver. Such a configuration enables visual elements of the simulation components to be changeable without affecting the data model module.

Multiple user interface paradigms may be used in the simulation. Further, multiple visual representations of a simulation component may be provided in the simulation. A visual representation may comprise a visual representation of more than one simulation component arranged according to the hierarchy.

Each of the at least one behavior driver may comprise one of a script, a rule, a programming language code, a decision tree, or a graphical language.

Authoring tools may be provided for defining the hierarchy of simulation components and inputting initial properties for the simulation components to provide an initial configuration for the simulation. The authoring tools enable inputting of initial values for the visual representations of the simulation components to provide an initial visual representation for the simulation components. The authoring tools enable inputting of a script, a rule, a programming language code, a decision tree, or a graphical language into the at least one behavior driver to specify the behaviors of the simulation components. The authoring tools may also enable configuring of the simulation components to enable specific training exercises.

In an example embodiment of the present invention, the data model module may further comprise an XML (Extensible Markup Language) interface that enables initialization of the data model module using XML.

The data model module may further comprise a listener interface for managing the interaction of simulation components. The listener interface may provide notifications to at least one of said interface engine, said at least one behavior driver, and a simulation engine which manages and controls the flow of time for the simulation.

The notifications may comprise a change notification specifying a change that has occurred or a pre-change notification specifying a change that is about to occur. The receiver of a pre-change notification may prevent the change from occurring or restrict the change. The notification may comprise at least one of a change in the data model, a change in one of the simulation components, a change in one of the properties, a change in the hierarchy, and a change in the visual representation of one of the simulation components.

The data model module may further comprise a query interface enabling determination of the hierarchy of the simulation components. The query interface enables namespace operations for locating a simulation component by name.

The data model module may further comprise a change interface enabling modification of at least one of the hierarchy and the properties of the simulation components allowing the at least one behavior driver to change the state of the simulation components.

A simulation event may be initiated via the user interface, causing the at least one behavior driver to change at least one of the properties of at least one of the simulation components. The visual representation will change in response to the change of at least one of the properties.

The system may also include a simulation engine for managing and controlling the flow of time for the simulation. The simulation engine may release simulation events requested via the user interface in a predetermined order and at a predetermined time in accordance with the simulation. The simulation engine may comprise an event submission interface for managing scheduled and repeating simulation events.

The simulation engine may further comprise an event processing interface for registering and unregistering event processors. The simulation engine may also include a time interface enabling at least one of the simulation time management, pausing of the simulation, speeding up of the simulation, and slowing down of the simulation.

The interface engine may control the hierarchy of the visual representations of the simulation components and manage interactions of the visual representations.

The state of the simulation may be represented as an n-tuple of the values of all properties of all the simulation components.

The user interactions with the simulation may be recorded for later playback. Real-time monitoring of the user interactions may be provided via an instructor workstation. Such real-time monitoring may occur remotely over a network.

The present invention also includes methods for providing simulation-based technical training, which are analogous to the system embodiments described above.

### BRIEF DESCRIPTION OF THE DRAWINGS

The present invention will hereinafter be described in conjunction with the appended drawing figures, wherein like reference numerals denote like elements, and:

FIG. 1 shows a block diagram of an example embodiment of the invention;

FIG. 2 shows a block diagram of a further example embodiment of the invention that includes extended services;

FIG. 3 shows a block diagram of a further example embodiment of the invention that includes authoring tools;

FIG. 4 shows a block diagram of a further example embodiment of the invention that includes external interfaces provided by the data model module;

FIG. 5 shows a flowchart illustrating the interaction of the data model module with various other simulation modules;

FIG. 6 shows a block diagram of a further example embodiment of the invention that includes internal interfaces provided by the simulation engine; and

FIG. 7 shows a block diagram of a further example embodiment of the invention that includes third party user interface libraries.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

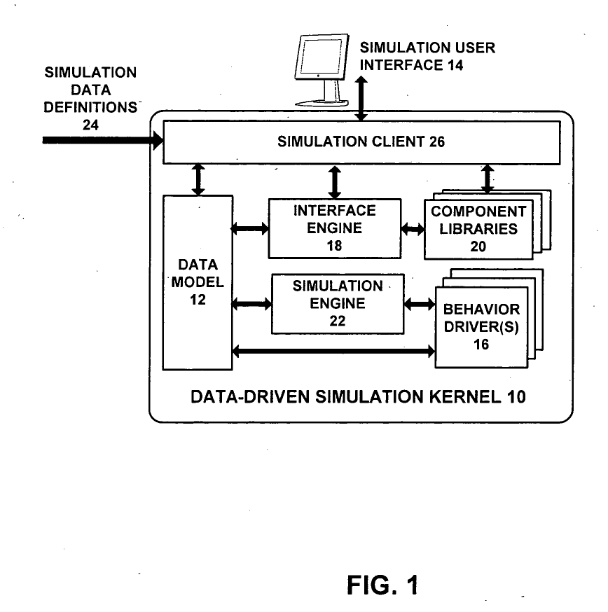

The present invention provides methods and systems for simulation-based technical training on equipment, machinery, and software-based systems. As shown in FIG. 1, the present invention is enabled by a data-driven simulation kernel 10. The data-driven simulation kernel 10 encapsulates the structure of the simulated system in a data model 12 that is decomposed into its constituent simulation components. Simulation components are structured hierarchically, mirroring the hierarchy of parts within parts in the actual system being simulated. Associated with each simulation component is a set of properties that define the user interface characteristics and states of that simulation component. The behavior of the simulation is driven by the sequence of state changes, specifically reflected as changes to the values of the properties of the constituent simulation components contained in the data model 12.

The architecture of the data-driven simulation kernel 10 shown in FIG. 1 includes a data model module 12, which encapsulates the run-time objects that represent the simulation components and their properties. One or more behavior drivers 16 specify the atomic simulation behaviors of simulation component property changes in response to user interactions (user events) and to changes in other simulation component properties. Behavior drivers 16 may be manifest as scripts, rules, programming language code or graphical languages. A simulation engine 22 may be provided for managing and controlling the flow of simulated time within the simulation kernel 10.

The interface engine 18 is the manager of the user interface 14 for a simulation, providing the user's simulated representation of the system, reflecting visual changes in response to simulation component property changes, and providing the conduit for user interactions with the simulation. The simulation client 26 provides the overall application resource management for the simulation during initial launch, execution, and shutdown. One of the important functions of the simulation client 26 is to provide input the initial data definitions for the simulation structure and properties and initialize the data model module 12. In addition, the simulation client 26 provides the overall user interface window(s) within which the simulation runs, which is also defined in data.

Component libraries 20 provide sets of reusable simulation components that encapsulate a visual representation, properties, and pre-defined behavior. The simulation components are integrated into a simulation by being referenced in the data model 12 for a simulation.

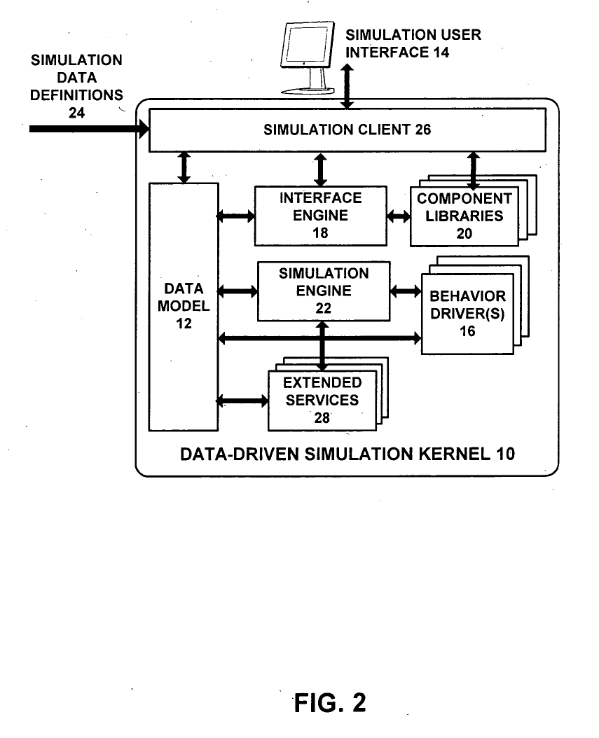

As shown in FIG. 2, the simulation kernel 10 supports the integration of extended services 28. Extended services 28 may include a wide variety of capabilities, including integration with external software systems, supporting collaboration between simulation users, and supporting various simulation applications for instruction, diagnostics, and certification.

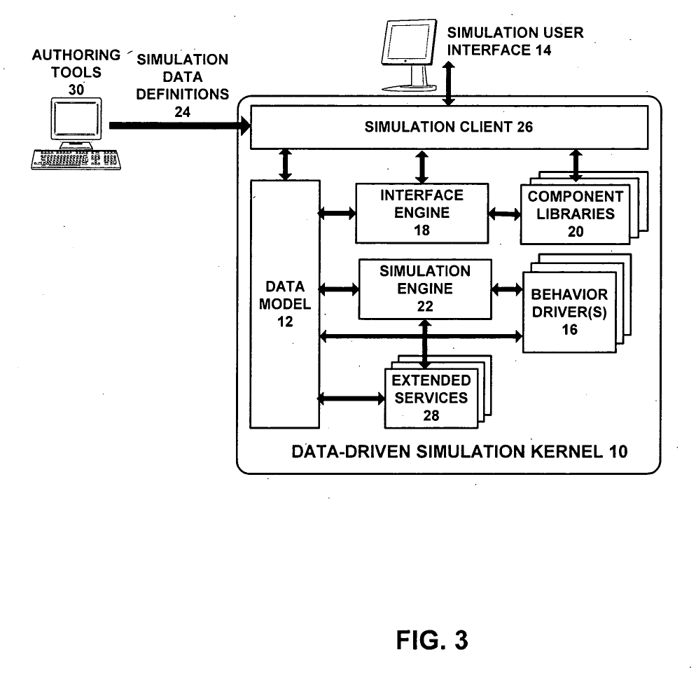

Another advantage of the data-driven simulation kernel 10 is the ability to integrate authoring tools 30, as shown in FIG. 3. Authoring tools 30 provide a special user interface for simulation developers to easily create and debug simulations.

The data-driven simulation kernel 10 may be initialized by a set of simulation data definitions 24 which may be provided in a structured format, such as XML (Extensible Markup Language). The simulation data definitions 24 may include the following:
Definition of the hierarchy of simulation components;
Definition of the properties of simulation components;
Definition of initial values for simulation components, including user interface characteristics (e.g., multimedia file(s), color, layout, transparency, associations) and initial state properties;
Selection of simulation components from the reusable component libraries and the configuration of their properties;
Resource definitions necessary for initializing and executing the simulation;
Configuration information for the simulation client, including its user interface structure, splash screens, language alternatives, licensing and authentication requirements, and external communication interfaces;
Configuration information for the simulation, including scenarios of operation, fault conditions, etc.;
Definition of guidance and remediation text and other media, including the definition of correct and incorrect user settings and actions for specific scenarios; and
Internal configuration of the simulation modules, plug-ins and extended services.

Each module of the data-driven simulation kernel will now be described in detail with reference to FIGS. 1-7. Those skilled in the art should appreciate that the descriptions provided below are of exemplary embodiments only.

Data Model 12

The data model 12 may encapsulate the run-time objects that represent the simulation components and their properties and manage their state as it relates to the other elements of the simulation. As such, the data model 12 provides the conduit for interactions between the interface engine 18 that manages the simulation user interface 14, the behavior driver(s) 16 that dictate the dynamic behavior of the simulation, and the simulation engine 22 that ensures that all behaviors occur in the proper sequence and timings.

The simulation data is represented as simulation components and properties. Simulation components are logical elements in the simulation, representing abstractions of actual hardware or software elements in the real system being simulated. Simulation components are organized hierarchically according to the parts hierarchy of the real system. (for example, a computer cabinet having several racks of components, a rack from the cabinet, a card from the rack, and an LED from the card may each be separate simulation components). Simulation components can be derived and specialized from existing simulation components in the component libraries 20. Properties represent specific simulation component information, and expose the states and other details for a simulation component. Properties always belong to a simulation component. At any time during the execution of the simulation, the state of the simulation is represented as the n-tuple of the values of all properties of all the simulation components.

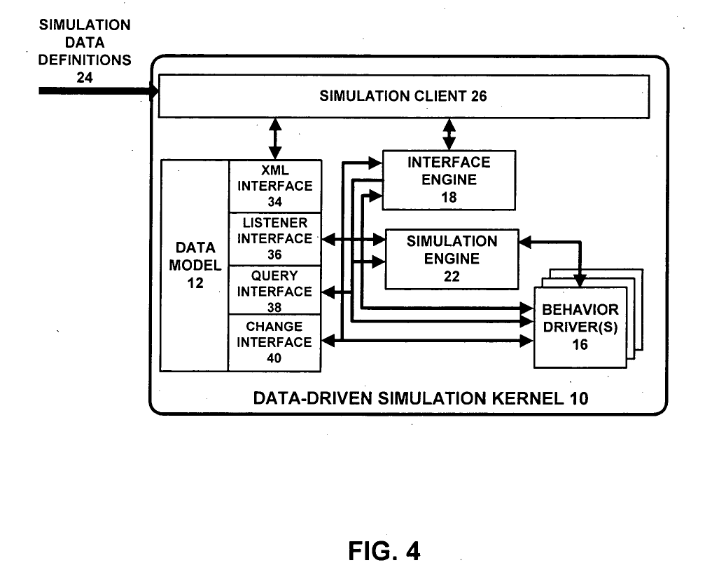

The data model 12, containing the structure, layout, and state of the simulation, separates the visual behavior of the simulation (managed by the interface engine 18) from the internal behavior of the simulation (in the behavior driver(s) 16). This separation offers significant advantages in constructing simulations:
Multiple user interface paradigms (e.g. 2D, 3D) may be employed in the same simulation;
Multiple user interface views of the same simulation component may be visually represented;
Visual elements may be changed, rearranged or replaced without affecting the data model;
Multiple ways of changing behavior may be employed. Multiple behavior drivers 16 may employ scripts, rules, code, or other methods to express behavior in the most efficient manner;
The data model 12 may be specified at the start of the simulation development, leading to improved development productivity; and
Developer tools may be used to further improve development productivity; The data model 12 provides four internal interfaces, as depicted in FIG. 4:
An XML Interface 34 - supports initializing the data model 12 from XML and provides a set of supporting functions, such as enabling and disabling the data model 12. The data is validated against the schema definition;
A Listener Interface 36 - provides a set of functions that allows other modules to be notified when the data model 12 changes or when properties on simulation components change. This interface, described in more detail below, manages the simulation interactions;
A Query Interface 38 - exposes the hierarchy of simulation component objects, supporting hierarchy traversal and namespace operations (finding a simulation component by name); and
A Change Interface 40 - supports modifications to the hierarchy of simulation components and modifications to the values of properties of simulation components. This interface allows the behavior driver(s) 16 to change the state of the simulation.

The listener interface 36 provides a set of services that orchestrate the interactions of the simulation. Other modules can register or unregister themselves to receive notification of prechanges, meaning that the notification occurs prior to a change, or of changes, meaning that the notification occurs after the change occurs. A module that receives notification of a prechange may veto or restrict the change, preventing not only that specific change, but also all immediate consequences of the change.

Notification of prechanges or changes may be made against:
A change in the data model 12, as a whole (i.e., changes in simulation components and/or their property definitions);
A change in a specific hierarchy of the data model 12;
A change in the model of a specific simulation component (i.e., the definition of its properties);
Any property data change of a specific simulation component; and
A specific property data change for a specific simulation component.

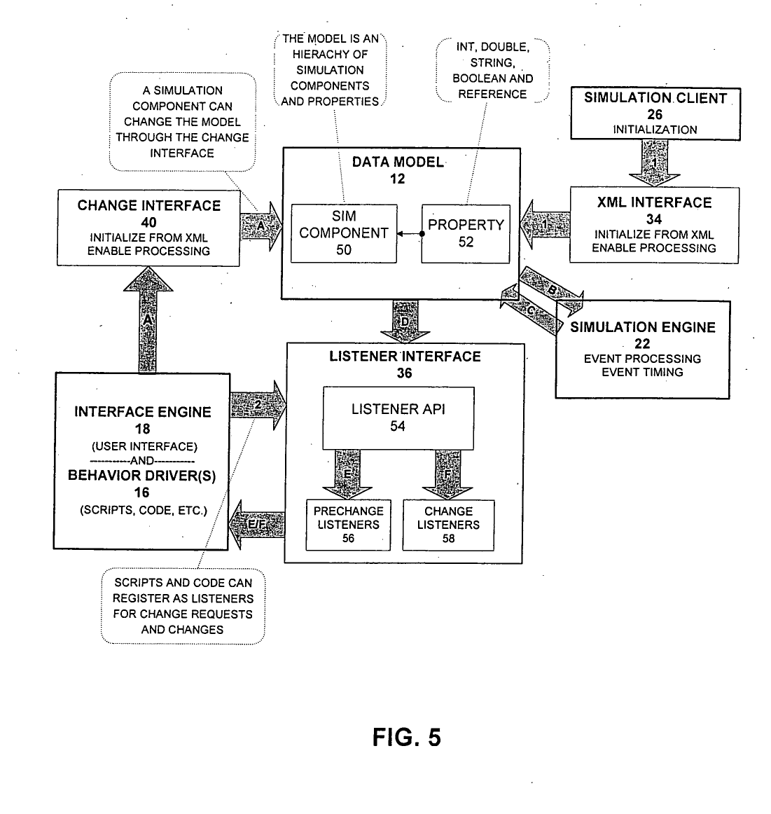

FIG. 5 shows an example of how the data model 12 interacts with the other simulation modules:
Initialization:

Arrow 1: The simulation client 26 initializes the data model 12 from XML, creating components 50 and properties 52.

Arrow 2: According to the definition of the user interface in the interface engine 18 and the behavior definitions in the behavior driver(s) 16 (typically code or scripts), these modules register as listeners to data model events.
Simulation running:

Arrow A: User interface interactions or changes initiated by behavior drivers 16 trigger model interactions, resulting in changes to property data 52 or changes to the data model 12.

Arrow B: The data model 12 creates a simulation event (SimEvent) and forwards it to the simulation engine 22 for time sequencing.

Arrow C: The simulation engine 22 processes the SimEvent, sending it back to the data model 12 at the appropriate time.

Arrow D: The data model 12 forwards the event to listener interface 36 for processing.

Arrow E. The listener interface 36 (via a listener API 54) processes all the prechange listeners 56 to check for restrictions. If a listener restricts the change, the change is rolled back, and processing stops.

Arrow F. The listener interface 36 (via the listener API 54) notifies all the change listeners 58 about the change.

Simulation Engine 22

The simulation engine 22 controls the flow of time within the simulation (i.e. simulated time). All processing that is time-related must interact with the simulation engine 22. Time-based requests are packaged as simulation events (SimEvents). The simulation engine 22 processes SimEvents synchronously.

The simulation engine 22 is responsible for the following functions:
Release requested SimEvents in the proper order and at the proper simulated time.
Handle time-sequenced series of SimEvents and time-repeating SimEvents.
Support both real-time and warp-time (arbitrary ratio to real-time—speeding up or slowing down of simulation) operations.
Support simulation pause and resume functions.
Provide an interface for plug-in extensions to the simulation kernel 10.

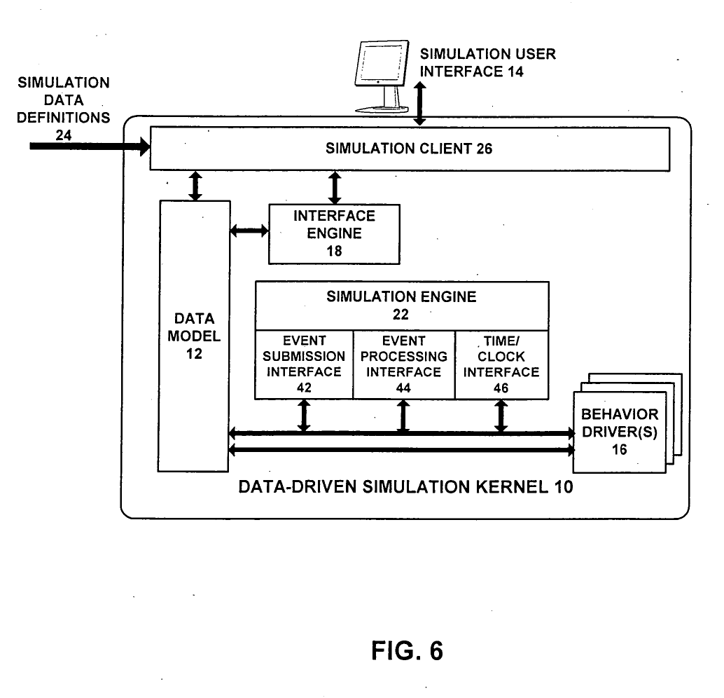

As illustrated in FIG. 6, the simulation engine 22 provides three internal interfaces:
Event Submission Interface 42—supports the submission of real-time, scheduled and repeating SimEvents.
Event Processing Interface 44—provides functions for-registering/unregistering event processors. In addition, it provides functions for event lifecycle management and logging.
Time/Clock Interface 46—supports basic simulation time management, including pause and time warp.

In controlling time within the simulation, the simulation engine 22 must also manage any software threads that are created within the simulation. Threads must be designed to respect the core simulation clock so that features like time warp and pause will work universally across all threads.

Behavior Driver(s) 16

Behavior driver(s) 16 encompass a wide class of methods and systems for specifying simulation behavior, including:
Scripts, including interpretive procedural languages such as Python, JavaScript, or Perl;
Rules, providing non-procedural specifications of behavior;
Code in a programming language such as Java, C++ or C#;
Decision trees;
Textual or graphical event sequencing languages; and
Textual or graphical state transition languages.

As depicted in FIG. 5, behavior driver(s) 16 register listeners against the data model 12 based upon what elements of the data model are determined to trigger behavior. Behavior driver(s) 16 respond to notifications of prechange or change to the data model 12 or to property data with other changes, thus reflecting the behavior of the simulation components. As such, a wide variety of methods may be employed to specify behavior equivalent to the form of “when this change occurs, make this other change.”

Interface Engine 18

The interface engine 18 is the manager of the simulation user interface 14. It is the conduit through which the user interface 14 interactions result in model or property data changes to the data model 12, and conversely, the mechanism by which changes in the data model 12 are reflected back in the user interface.

The interface engine 18 has the following responsibilities:
Control the visual component hierarchy and manage visual component interactions;
Map the bi-directional interactions between the data model 12 and the visual components;
Control visual component resource management via the simulation client 26; and
Record and replay user events.

As shown in FIG. 5, the interface engine 18 uses the listener interface 36 of the data model 12 to trigger user interface changes in response to data model changes. The interface engine 18 uses the change interface 40 of the data model 12 to set property data values based upon user interaction.

Simulation Client 26

The simulation client 26 provides the overall application resource management for the simulation during initial launch, execution, and shutdown. The key functions of the simulation client 26 are as follows:
Simulation initialization and life cycle management. The simulation client 26 inputs the initial data definitions for the simulation structure and properties and initializes the data model module 12.
Resource management. The simulation client 26 organizes and manages all relevant code, libraries, configuration data, multimedia data files, simulation definition data and associated meta-data.
Communications and simulation control. The simulation client 26 accomplishes the necessary external communications, if necessary, to setup and control the simulation.
Simulation meta-UI. The simulation client 26 provides the overall user interface navigation and the window(s) within which the simulation runs. The simulation UI is defined and configurable through data definitions.
Deployment configuration, security, licensing and internationalization. The simulation client 26 is responsible for managing all of the aspects of packaging and deployment.
   Component Libraries 20

Component libraries 20 are sets of reusable simulation components that encapsulate a visual representation of the simulation component, its properties, and pre-defined behavior. A simulation component may use or encapsulate other simulation components. The simulation components may be integrated into a simulation by being referenced in the data model 12 for a simulation.

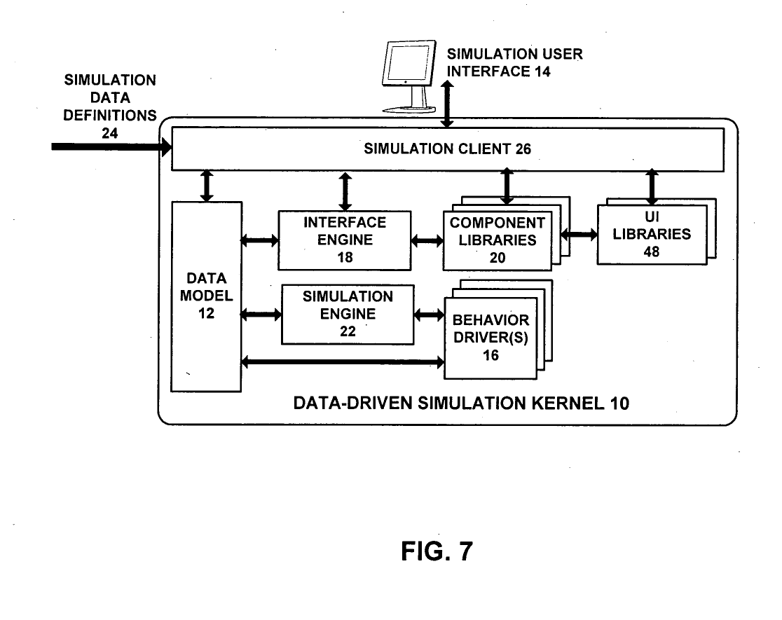

As shown in FIG. 7, one characteristic of the component architecture is its ability to directly utilize third party user interface libraries 48, such as Swing or Java 3D, without requiring modification or wrapping. Visual components in the component libraries 20 are constructed that map into-simulation components in the data model 12. These components directly use the low-level components of a third party UI (user interface) library 48. The “lightweight” components of the UI library 48 do not have a presence in the data model 12 and are controlled by the visual simulation components. This capability allows the simulation kernel 10 to be extensible to support a wide variety of UI libraries 48 and therefore support a wide variety of user interface technologies and styles.

It should now be appreciated that the present invention provides advantageous methods and systems for providing simulation-based technical training.

Although the invention has been described in connection with various illustrated embodiments, numerous modifications and adaptations may be made thereto without departing from the spirit and scope of the invention as set forth in the claims.

1. A system for providing simulation-based technical training, comprising:
a data model module for a simulation comprised of:
a set of simulation components, each of which represents a corresponding component of a system to be simulated, said set of simulation components being structured in a hierarchy which mirrors a hierarchy of said corresponding components of said system; and
a set of properties associated with each of said simulation components, said properties defining characteristics of a user interface for simulating the respective simulation component and states of the respective simulation component;
a user interface for enabling user interactions with said system and providing a visual representation of at least one of said simulation components based on at least one of said properties;
at least one behavior driver for specifying respective behaviors of said simulation components corresponding to respective changes of at least one of said properties; and
an interface engine for managing said user interface and changing said visual representation based on said property changes in accordance with said at least one behavior driver in response to said user interactions.

2. A system in accordance with claim 1, further comprising:
a simulation client for providing application resource management for said simulation during initial simulation launch, execution, and shutdown.

3. A system in accordance with claim 2, wherein said simulation client further provides initial data definitions for said properties and for a structure of the simulation.

4. A system in accordance with claim 2, wherein said simulation client initializes said data model module.

5. A system in accordance with claim 2, wherein said simulation client configures and controls said user interface.

6. A system in accordance with claim 1, further comprising:
one or more component libraries, each of which contains a set of reusable simulation components.

7. A system in accordance with claim 6, further comprising:
one or more third-party user interface libraries coupled to said component libraries, said user interface libraries comprising low-level components that map to visual components in said component libraries for use by a simulation component.

8. A system in accordance with claim 1, wherein each simulation component encapsulates a visual representation of said component, said properties of said component, and predefined behavior of said component.

9. A system in accordance with claim 8, wherein at least one of said simulation components encapsulates a related simulation component.

10. A system in accordance with claim 1, wherein said simulation components are integrated into a simulation by being referenced in the data model module.

11. A system in accordance with claim 1, wherein:
visual behavior of said simulation is managed by said interface engine; and internal behavior of said simulation is managed by said at least one behavior driver.

12. A system in accordance with claim 11, wherein visual elements of said simulation components are changeable without affecting the data model module.

13. A system in accordance with claim 1, wherein multiple user interface paradigms are used in said simulation.

14. A system in accordance with claim 1, wherein multiple visual representations of a simulation component are provided in said simulation.

15. A system in accordance with claim 1, wherein said visual representation comprises a visual representation of more than one simulation component arranged according to said hierarchy.

16. A system in accordance with claim 1, wherein each of said at least one behavior driver comprises one of a script, a rule, a programming language code, a decision tree, or a graphical language.

17. A system in accordance with claim 1, wherein:
at least one of said simulation components comprises a reusable simulation component.

18. A system in accordance with claim 1, further comprising:
authoring tools for defining the hierarchy of simulation components and inputting initial properties for said simulation components to provide an initial configuration for said simulation.

19. A system in accordance with claim 18, wherein:
said authoring tools enable inputting of initial values for said visual representations of said simulation components to provide an initial visual representation for said simulation components.

20. A system in accordance with claim 18, wherein:
said authoring tools enable inputting of a script, a rule, a programming language code, a decision tree, or a graphical language into said at least one behavior driver to specify the behaviors of said simulation components.

21. A system in accordance with claim 18, wherein:
said authoring tools enable configuring of said simulation components to enable specific training exercises.

22. A system in accordance with claim 1, wherein said data model module further comprises:
an XML interface which enables initialization of said data model module using XML.

23. A system in accordance with claim 1, wherein said data model module further comprises:
a listener interface for managing the interaction of simulation components.

24. A system in accordance with claim 23, wherein said listener interface provides notifications to at least one of said interface engine, said at least one behavior driver, and a simulation engine which manages and controls the flow of time for said simulation.

25. A system in accordance with claim 24, wherein said notifications comprise:
a change notification specifying a change that has occurred; or
a pre-change notification specifying a change that is about to occur.

26. A system in accordance with claim 25, wherein the receiver of a pre-change notification may prevent the change from occurring or restrict the change.

27. A system in accordance with claim 24, wherein said notification comprises at least one of a change in the data model, a change in one of said simulation components, a change in one of said properties, a change in said hierarchy, and a change in the visual representation of one of said simulation components.

28. A system in accordance with claim 1, wherein said data model module further comprises:
a query interface enabling determination of the hierarchy of said simulation components.

29. A system in accordance with claim 28, wherein said query interface enables-namespace operations for locating a simulation component by name.

30. A system in accordance with claim 1, wherein said data model module further comprises:
a change interface enabling modification of at least one of said hierarchy and said properties of said simulation components allowing said at least one behavior driver to change said state of said simulation components.

31. A system in accordance with claim 1, wherein:
a simulation event is initiated via said user interface, causing said at least one behavior driver to change at least one of said properties of at least one of said simulation components; and
said visual representation changes in response to said change of at least one of said properties.

32. A system in accordance with claim 1, further comprising:
a simulation engine for managing and controlling the flow of time for said simulation.

33. A system in accordance with claim 32, wherein said simulation engine releases simulation events requested via said user interface in a predetermined order and at a predetermined time in accordance with said simulation.

34. A system in accordance with claim 32, wherein said simulation engine further comprises:
an event submission interface for managing scheduled and repeating simulation events.

35. A system in accordance with claim 32, wherein said simulation engine further comprises:
an event processing interface for registering and unregistering event processors.

36. A system in accordance with claim 32, wherein said simulation engine further comprises:
a time interface enabling at least one of said simulation time management, pausing of said simulation, speeding up of said simulation, and slowing down of said simulation.

37. A system in accordance with claim 1, wherein said interface engine controls said hierarchy of said visual representations of said simulation components and manages interaction of said visual representations.

38. A system in accordance with claim 1, wherein the state of the simulation is represented as an n-tuple of the values of all properties of all the simulation components.

39. A system in accordance with claim 1, wherein:
said user interactions with said simulation are recorded for later playback.

40. A system in accordance with claim 1, wherein:
real-time monitoring of said user interactions is provided via an instructor workstation.

41. A system in accordance with claim 40, wherein said real-time monitoring occurs remotely over a network.

42. A method for providing simulation-based technical training, comprising:
creating a data model module for a simulation by:
defining a set of simulation components, each of which represents a corresponding component of a system to be simulated, said set of simulation components being structured in a hierarchy which mirrors a hierarchy of said corresponding components of said system; and
defining a set of properties associated with each of said simulation components, said properties defining characteristics of a user interface, for simulating the respective simulation component and states of the respective simulation component;
providing a user interface for enabling user interactions with said system and providing a visual representation of at least one of said simulation components based on at least one of said properties;
specifying respective behaviors of said simulation components corresponding to respective changes of at least one of said properties; and
managing said user interface and changing said visual representation based on said property changes in accordance with said behaviors in response to said user interactions.

43. A method in accordance with claim 42, further comprising:
providing a simulation client for providing application resource management for said simulation during initial simulation launch, execution, and shutdown.

44. A method in accordance with claim 43, wherein said simulation client further provides initial data definitions for said properties and for a structure of the simulation.

45. A method in accordance with claim 43, wherein said simulation client initializes said data model module.

46. A method in accordance with claim 43, wherein said simulation client configures and controls said user interface.

47. A method in accordance with claim 42, further comprising:
providing one or more component libraries, each of which contains a set of reusable simulation components.

48. A method in accordance with claim 47, further comprising:
providing one or more third-party user interface libraries coupled to said component libraries, said user interface libraries comprising low-level components that map to visual components in said component libraries for use by a simulation component.

49. A method in accordance with claim 42, wherein each simulation component encapsulates a visual representation of said component, said properties of said component, and predefined behavior of said component.

50. A method in accordance with claim 49, wherein at least one of said simulation components encapsulates a related simulation component.

51. A method in accordance with claim 42, wherein said simulation components are integrated into a simulation by being referenced in the data model module.

52. A method in accordance with claim 42, wherein:
visual behavior of said simulation is managed by an interface engine; and
internal behavior of said simulation is managed by at least one behavior driver.

53. A method in accordance with claim 52, wherein visual elements of said simulation components are changeable without affecting the data model module.

54. A method in accordance with claim 42, wherein multiple user interface paradigms are used in said simulation.

55. A method in accordance with claim 42, further comprising:
providing multiple visual representations of a simulation component in said simulation.

56. A method in accordance with claim 42, wherein said visual representation comprises a visual representation of more than one simulation component arranged according to said hierarchy.

57. A method in accordance with claim 42, wherein:
at least one behavior driver is provided for said specifying of the respective behaviors of the simulation components; and
each of said at least one behavior driver comprises one of a script, a rule, a programming language code, a decision tree, or a graphical language.

58. A method in accordance with claim 42, wherein:
at least one of said simulation components comprises a reusable simulation component.

59. A method in accordance with claim 42, further comprising:
providing authoring tools for defining the hierarchy of simulation components and inputting initial properties for said simulation components to provide an initial configuration for said simulation.

60. A method in accordance with claim 59, wherein:
said authoring tools enable inputting of initial values for said visual representations of said simulation components to provide an initial visual representation for said simulation components.

61. A method in accordance with claim 59, wherein:
said authoring tools enable inputting of a script, a rule, a programming language code, a decision tree, or a graphical language into at least one behavior driver to specify the behaviors of said simulation components.

62. A method in accordance with claim 59, wherein:
said authoring tools enable configuring of said simulation components to enable specific training exercises.

63. A method in accordance with claim 42, wherein said creating of said data model module further comprises:
providing an XML interface which enables initialization of said data model module using XML.

64. A method in accordance with claim 42, wherein said creating of said data model module further comprises:
providing a listener interface for managing the interaction of simulation components.

65. A method in accordance with claim 64, wherein said listener interface provides notifications to at least one of an interface engine, at least one behavior driver, and a simulation engine which manages and controls the flow of time for said simulation.

66. A method in accordance with claim 65, wherein said notifications comprise:
a change notification specifying a change that has occurred; or
a pre-change notification specifying a change that is about to occur.

67. A method in accordance with claim 66, wherein the receiver of a pre-change notification may prevent the change from occurring or restrict the change.

68. A method in accordance with claim 65, wherein said notification comprises at least one of a change in the data model, a change in one of said simulation components, a change in one of said properties, a change in said hierarchy, and a change in the visual representation of one of said simulation components.

69. A method in accordance with claim 42, wherein said creating of said data model module further comprises:
providing a query interface enabling determination of the hierarchy of said simulation components.

70. A method in accordance with claim 69, wherein said query interface enables namespace operations for locating a simulation component by name.

71. A method in accordance with claim 42, wherein said creating of said data model module further comprises:
a change interface enabling modification of at least one of said hierarchy and said properties of said simulation components allowing at least one behavior driver to change said state of said simulation components.

72. A method in accordance with claim 42, wherein:
a simulation event is initiated via said user interface, causing at least one behavior driver to change at least one of said properties of at least one of said simulation components; and
said visual representation changes in response to said change of at least one of said properties.

73. A method in accordance with claim 42, further comprising:
providing a simulation engine for managing and controlling the flow of time for said simulation.

74. A method in accordance with claim 73, wherein said simulation engine releases simulation events requested via said user interface in a predetermined order and at a predetermined time in accordance with said simulation.

75. A method in accordance with claim 73, wherein said simulation engine comprises:
an event submission interface for managing scheduled and repeating simulation events.

76. A method in accordance with claim 73, wherein said simulation engine comprises:
an event processing interface for registering and unregistering event processors.

77. A method in accordance with claim 73, wherein said simulation engine comprises:
a time interface enabling at least one of said simulation time management, pausing of said simulation, speeding up of said simulation, and slowing down of said simulation.

78. A method in accordance with claim 42, wherein an interface engine controls said hierarchy of said visual representations of said simulation components and manages interaction of said visual representations.

79. A method in accordance with claim 42, wherein the state of the simulation is represented as an n-tuple of the values of all properties of all the simulation components.

80. A method in accordance with claim 42, further comprising:
recording said user interactions with said simulation for later playback.

81. A system in accordance with claim 42, further comprising:
real-time monitoring of said user interactions via an instructor workstation.

82. A method in accordance with claim 81, wherein said real-time monitoring occurs remotely over a network.
